(19) United States
(12) Patent Application Publication
(10) Pub. No.: US 2006/0198132 A1
(43) Pub. Date: Sep. 7, 2006

(54) Portable work light

(76) Inventors: Phil Trigiani, Mississauga (CA); Tony Ferraro, Mississauga (CA); Richard Robert Coulson, Ontario (CA)

Correspondence Address: BELL, BOYD & LLOYD, LLC, PO BOX 1135, CHICAGO, IL, 60690-1135, US

(21) Appl. No.: 11/321,666

(22) Filed: Dec. 29, 2005

Related U.S. Application Data
(60) Provisional application No. 60/659,746, filed on Mar. 7, 2005.

(51) Int. Cl. F21L 4/08; F21L 4/04

(52) U.S. Cl. 362/183; 362/205; 362/222

(57) ABSTRACT

The present specification discloses a work light having a tray for holding or positioning light components such as a light source, power source and electrical control unit. The components can easily be assembled on the tray for operation of the light. The tray can be compartmentalized by including barriers into which the modular components of the light fit. Such barriers provide for very simple assembly or replacement of the components and protect the components by limiting their movement with respect to each other. In an embodiment the tray contains a compartment for holding an electronic control unit. The tray can contain a battery compartment which can hold a battery powered power source. The tray can also contain a light source compartment for holding a light source. The tray can be supported by a housing or casing containing a light transmissible portion which surrounds at least a portion of the tray. A cap having a hollow shell body with an opening at one end can be used to close the end of the housing. In an embodiment the cap can have a rotatable hook, which extends away from the work light, that can be used to suspend the work light in a work environment.

### CROSS REFERENCE TO RELATED APPLICATIONS

This application claims priority to U.S. Provisional Application No. 60/659,746 filed on Mar. 7, 2005.

### BACKGROUND OF THE INVENTION

Service technicians are often required to perform repair services in areas that are difficult to access and are poorly lit. They commonly employ work lights to provide additional illumination in these areas. The work light can be placed in a variety of positions in a work area to direct a sufficient amount of additional light into a work space, as needed. Such lights need to be relatively compact and portable, yet they must be able to provide light in sufficient quantity, with a large enough beam to be concentrated upon the part or element being repaired.

These devices are well known by such names as work lights, trouble lights, utility lights, inspection lights and the like.

Because work lights are employed in many different work environments, such as vehicle repair, maintenance work, construction and the like; the lights are subject to impacts, shocks, falls, drops, harsh chemicals, and large temperature changes from below freezing to significant heat, such as from a motor vehicle engine. As a consequence, work lights often suffer damage. Some damage can be severe and may cause the light to cease functioning.

Work light repair can be a lengthy procedure requiring delivery of the non-functioning light to a repair facility, repair and then return of the work light to its owner. This is an inefficient and time-consuming process.

Thus, a new work light providing for a simple method of “on-site” repair that can be easily and quickly performed is needed. Ideally such work lights can also be manufactured more efficiently.

### SUMMARY OF THE INVENTION

A work light having a tray, which can be compartmentalized, for holding light components including a light source, power source and electrical control unit is disclosed. The components can easily be assembled on the tray for operation of the light. The tray can include barriers into which modular components of the light can fit. The barriers simplify assembly or replacement of the modular components and protects the components by limiting their movement with respect to each other. In an embodiment, the tray contains an electronic control unit compartment which can hold an electronic control unit. The tray can contain a battery compartment which can hold a battery powered power source. The tray can also contain a light source compartment that can hold a light source. The tray is held by a housing or casing containing a light transmissible portion which surrounds it. A cap having a hollow shell body with an opening at one end can be used to close the end of the housing. In an embodiment the cap can have a rotatable hook, which extends away from the work light, that can be used to suspend the work light in a work environment.

In an embodiment, a portion of the work light tray can be surrounded by a housing having a light transmissible region, wherein the housing is extended in a longitudinal direction and is open at one of its ends such that the tray can be inserted and removed through the opening.

In an embodiment, the work light tray can be surrounded by a housing having a light transmissible portion enclosed by a cap having a hollow shell body with an opening at one end.

In an embodiment, the work light tray can be surrounded by a housing having a light transmissible portion wherein the light transmissible portion is engaged with a handle portion comprising a hollow body portion having an opening at one end for engaging a portion of the housing.

In an embodiment, the work light tray can be surrounded by a housing having a light transmissible portion that is frictionally engaged with a handle portion comprising a hollow body portion with an opening at one end for frictionally engaging the lower portion of the housing.

In an embodiment, the work light tray can be surrounded by a housing having a light transmissible portion engaged with a handle portion comprising a hollow body potion with an opening at one end for engaging the lower portion of the housing wherein a portion of the handle has an elastomeric or rubberized grip having a flexible property.

In an embodiment the work light tray comprises a switch which is adapted to receive a modular electronic control unit containing a printed circuit board containing a mechanical switch in electrical contact with a power source and a light source. The power source can be a battery or solar powered source.

In an embodiment, the work light tray contains an electronic control which is adapted to receive a modular electronic control unit containing a printed circuit board comprising a mechanical switch in electrical contact with a rechargeable battery power source and a light source and the modular electronic control unit also contains a connector jack for connection to an external power source for recharging the rechargeable battery power source.

Additional features and advantages of the present invention are described in, and will be apparent from, the following Detailed Description of the Invention and the figures.

### BRIEF DESCRIPTION OF THE FIGURES

FIG. 1 illustrates an exploded view of an embodiment of the work light of the invention.

FIG. 2 illustrates an embodiment of a work light assembly.

FIG. 3 illustrates an embodiment of the tray assembly for a work light of the invention.

FIG. 4 illustrates an embodiment of the tray platform.

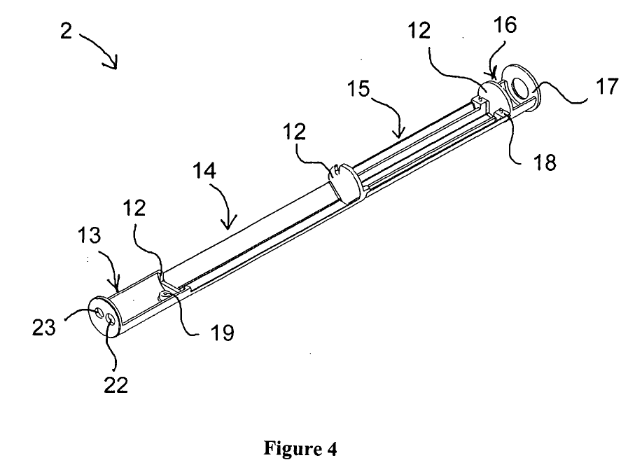

### DETAILED DESCRIPTION OF THE INVENTION

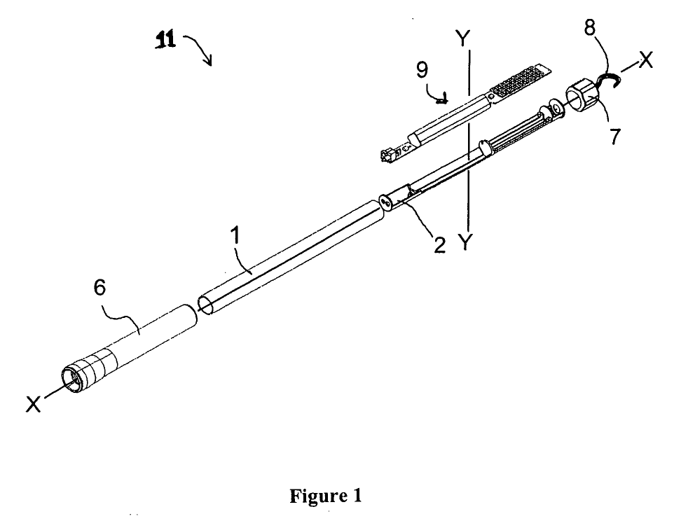

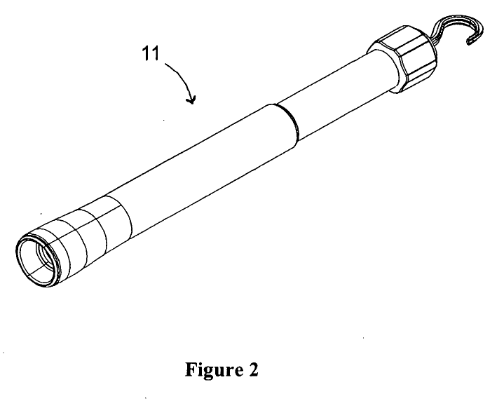

Referring to FIGS. 1 and 2, the present invention will be seen to relate to a highly serviceable, portable work light 11. As illustrated, the invention provides a light source operably connected to components that include a power source and an electronic control mechanism. In an embodiment, the components of the device can be assembled on a support tray 2 which can be inserted in an extended hollow body or housing 1. Internal components 9 of work light 11, including a power source 3, a light source 4 and an electronic control mechanism 5 can be located on support tray 2. The components can be adapted such that they fit into compartments in the tray in a unique manner such that they can be conveniently replaced.

The hollow body 1 of work light 11 has a transparent, light transmissible portion and can have an opening at one or both ends, as illustrated in FIG. 1. Body 1 is preferably made of a resilient plastic material. The body can have a light-transmissive portion and can be adapted to join a handle portion 6. The body can have any suitable shape and is generally hollow and open at least on one end so that it can receive support tray 11 containing the internal work light components.

A removable cap 7 can cover hollow body 1, as in the illustrated embodiment, and retain the tray inside hollow body 1. A rotatable hook 8 can extend from the cap. In an embodiment, cap 7 has a hollow shell body with an opening at one end and is made from an elastomeric material of which many are known. In the illustrated embodiment cap 7 encapsulates the open end of the housing 1 opposite from the handle portion 6. The cap is equipped with a hook 8 which can be snapped or secured by mechanical means into a hole located on the cap. Preferably, the hook 8 engages cap 7 with sufficient friction force so the hook can be rotated to set the work light in a desired position for use and then maintain this set position. The outside shape of the cap allows for multiple, stable, and predictable resting surfaces to allow for optimum orientation of the light. Preferably, the cap 7 has an internal diameter that is slightly smaller than the diameter of housing 1, to frictionally engage the housing 1. While the fiction fit is designed to secure the cap in place on to the housing 1, it can be overcome with sufficient force to allow for service of the support tray 2 and the internal components 9.

The work light can have a handle portion 6. Handle portion 6 can include a hollow body with openings at one or both ends and can engage or enclose the lower portion of housing 1. The internal diameter of handle portion 6, preferably, is a suitable diameter for frictionally engaging housing 1 when assembled. Handle portion 6 can be configured with an elastomeric or rubberized grip having a flexible property which allows the work light 11 to be held comfortably for extended periods of time. The grip protects housing 1 from impacts and corrosive chemicals.

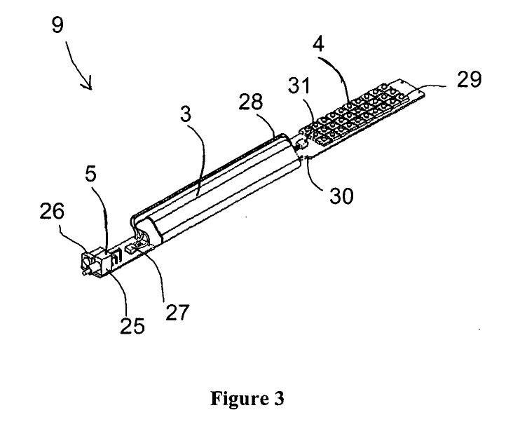

The work light has a control device 5, as illustrated best in FIG. 3. Control device 5 can be inserted into the switch compartment 13 of the support tray 2 and secured to the support tray 2 with a mechanical screw inserted into a mounting boss 19 in the switch compartment 13 of the support tray 2. The control device 5 can include a printed circuit board (PCB) that contains a mechanical switch 25 and a known connector 27 removably attached to a battery pack 3 and an electrical wire 28 removably connected to light source 4. Wire 28 is electrically conductive and is electrically and mechanically attached to the light source 4 with a known connector 31. Wire 28 can be efficiently assembled or removed for either assembly or repair.

In the preferred embodiment, the control mechanism is an electric switch mounted to a printed circuit board (PCB). The switch can be located at one end of the PCB as illustrated, and can protrude though a mounting hole in tray 22. The switch can be secured to the support tray 2 mechanically with a nut. The control mechanism when switched to the “on” position will electrically connect the power source to the light source to illuminate the lights. In the “off” position, the electrical connection is broken and the lights are not illuminated. In an embodiment, the control device also contains a connector jack 26 for connection to an external power source which can be plugged into the connector jack 26 for recharging a battery pack 3.

In a preferred embodiment, the power source is an array of rechargeable battery cells electrically joined together to form a single power source device. A wire extends from this battery pack device and is removably connected to the control mechanism with a standard type mating electrical connector. However, other power sources can also be used including an alternating current power source or solar power.

Battery pack 3 can be inserted into battery compartment 14 of support tray 2 and retained between the barriers 9 which frame the ends of battery compartment. Battery pack 3 can be chosen to be of a suitable size to be retained between support tray 2 and the inside diameter of housing 1. The battery pack can be electrically connected to the control device by a standard well-known connector 27 that allows for efficient assembly and replacement during either assembly or repair.

In a preferred embodiment, the light source 4 is an array of light emitting diodes (LEDs) mounted to a printed circuit board; however, other light sources might be used, such as a fluorescent lamp, a high intensity discharge (HID) lamp, halogen lamp, and the like. The LEDs can be grouped together in a desired pattern to provide a sufficient light intensity for a work light. The array of LEDs may be composed of LEDs with different light, electrical and physical properties, such as light intensity, illumination angle, color, voltage, electrical current, size, shape, and the like. Various patterns of LEDs can be used, including a pattern wherein the LEDs are tilted toward a central longitudinal axis to focus light or away from a central axis for more diffused light.

In an embodiment, the work light contains a removable tray which provides for organizing the serviceability and reparability of the work light in the field and improves the efficiency of manufacturing. The tray provides a support structure for each of the components contained inside the hollow body of the light. Thus, the lighting 4, power source 3, and control switch 26 can be mounted along a horizontal longitudinal axis. These components move with the tray when the tray is either inserted or removed from the hollow body of the work light. When the tray is apart from the hollow body, the components on the tray are accessible for service or replacement.

Support tray 2 has a width slightly smaller than the internal diameter of housing 1 such that support tray 2 can be easily inserted or removed from housing 1. By being able to remove support tray 2, the internal components 9 of the work light can be easily serviced or repaired. Support tray 2 itself can have several compartments to support each component it supports. In the illustrated embodiment, the tray has 4 compartments 13, 14, 15 and 16; other embodiments may vary the number and position of the compartments. In an embodiment, a barrier 12 separates each compartment. The barrier prevents the internal components 9 from moving relative to each other. The compartments 13, 14, 15 and 16 of the support tray have openings in the direction of the assembly axis Y-Y. In the illustrated embodiment, the internal components can be assembled from the same side and direction of the assembly axis Y-Y. In an alternate embodiment, the components are assembled into positions on both sides of the support tray. Each compartment is sized to receive an internal component. These features of the support tray facilitate efficient and easy assembly of the internal components into the support tray. Support tray 2 also has flange 17 at one end with an outer diameter that is as large as the interior diameter housing 1. This allows flange 17 to rest upon the end of the housing 1 and position the internal components 9 at their correct resting position.

The removable tray allows for flexible manufacturing of the work light. The structural characteristics of the tray allow varied components to be held in place. Certain components may have unique configurations to suit particular needs or requirements. For example, the light source component may have an alternate configuration that uses 20 LEDs instead of 30 LEDs on a light source PCB to provide a lower cost work light to the market. Unique variations of particular components will generally share common support methods and connections, and will therefore fit onto the tray in the same manner. Each configuration of a particular component will also generally connect with the other components of the light in a similar manner. For example, different configurations of the LED board could all employ the same electrical and mechanical connectors. This ensures that other components of the light such as the control mechanism will interact properly with the different configurations of the light source LED PCB and further provides for flexibility manufacturing. Thus, different models of the work light can be easily manufactured by substituting an alternate component or components. Cost savings can be achieved by using standardized components, such as the battery pack in many different configurations of the work light, both for the initial purchase of the component, because a larger quantity is used over many products, and by supplying a standardized replacement part.

The tray simplifies the in-field repair of the work light. For example, in one embodiment the cap can be removed from the work light, providing access to the tray. The tray can be easily and quickly inserted or removed from the hollow body of the work light along a longitudinal axis.

In one embodiment, the tray has a single component loading direction; other embodiments may contain multiple loading directions.

In embodiments having a compartmentalized tray, the tray facilitates the proper alignment of components both to each other and to the hollow body by providing designated compartments, one for each of the individual components. Locating features can be provided on compartments which further assist in registering the correct orientation of components. The work light components can then be inserted into the tray in their designated compartments. The method of securing components can vary depending upon the component.

For example, in an embodiment a light source device 4 can be assembled by placing it into the support tray 2 along the Y-Y axis onto support surface 18 in the light compartment 15. The light support surface of the compartment sets both the orientation and height of the light source device 4. Notches 30 on the light source 4 ensure that the light source 4 can only be inserted into the support tray 2 in the correct orientation.

The tray can be equipped with a registration method that aligns the tray to the hollow body. This registration method may take the form of a pin and socket or interconnecting ribs and channels.

The shock or impact that the work light and therefore the internal components may receive can be severe. This can cause components to shift their location in the work light. If these components, and in particular components such as the battery pack with a relatively large mass, shift due to this force, other portions of the light could be damaged. To avoid this, in an embodiment, the tray incorporates barriers between the components that isolate and limit the movement of these components, so damage is avoided.

In the case of a work light that has been damaged and no longer functions, the malfunctioning component can be separated from the tray and either repaired or replaced with a new component. Such an “in-field” repair can be performed with commonly available tools. In an embodiment, the internal components have a unique orientation with respect to the tray such that the components cannot be inserted in an incorrect orientation and will not fit correctly into the wrong location.

In an embodiment, repair can be effected by first removing the rubber cap from hollow body 1. The tray can then be removed from the hollow body along its longitudinal axis. The non-functioning component can then be removed from the tray and replaced with a functioning version. The tray can be returned into the hollow body to its original position. The cap can be replaced on the hollow body securing the tray in place.

The work light 11 can be constructed along two principle axis, a longitudinal axis X-X for the transparent housing 1 and support tray 2 and a component assembly axis Y-Y for the internal components 9 assembled onto the support tray 2.

In an embodiment, the component assembly axis Y-Y is perpendicular to the longitudinal axis. In an embodiment, a plurality of component axes exist at varying angles to each other. By having a common assembly axis Y-Y, the work light can be assembled in an efficient manor. The support tray can be positioned in a single orientation and does not have to be repositioned to insert the various internal components 9.

Light assembly typically requires each individual component to be inserted into the body, in sequence; requiring a separate insertion motion for each. With each component inserted, positioning adjustments are typically made to ensure the assembly is of good quality. However, use of certain embodiments of the present invention eliminates the need for positioning adjustments of the internal components that are time consuming to perform. The tray allows for easy inspection of component placement to assure the assembly is of good quality. The tray also allows the internal components to be inserted in one motion without reorientation and thereby reduces the time require to assemble the work light.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A work light comprising an elongated housing having a light transmissible region that surrounds a portion of a removable tray holding removable work light components.

2. The work light of claim 1, wherein the work light components are selected from the group of components consisting of a light source, a power source, and an electrical control mechanism.

3. The work light of claim 1, wherein the tray includes barriers between the work light components that limit the movement of the components relative to each other.

4. The work light of claim 1, wherein the tray includes barriers between the components that limit the movement of the components relative to each other and the components are operably connected on the same side of the tray.

5. The work light of claim 1, wherein a portion of the tray is surrounded by a housing having a light transmissible region.

6. The work light of claim 1, wherein the tray is surrounded by a housing having a light transmissible region, wherein the housing is extended in a longitudinal direction and is open at one of its ends such that the tray can be inserted and removed through the opening.

7. The work light of claim 1, wherein the tray is surrounded by a housing having a light transmissible portion enclosed by a cap having a hollow shell body portion and an opening at one end.

8. The work light of claim 1, wherein the tray is surrounded by a housing having a light transmissible portion enclosed by a cap having a hollow shell body with an opening at one end and a rotatable hook extending from the cap.

9. The work light of claim 1, wherein the tray is surrounded by a housing having a light transmissible portion engaged to a handle portion comprising a hollow body with an opening at one end for engaging the lower portion of the housing.

10. The work light of claim 1, wherein the tray is surrounded by a housing having a light transmissible portion frictionally engaging a handle portion comprising a hollow body with an opening at one end for frictionally engaging a portion of the housing.

11. The work light of claim 1, wherein the tray is surrounded by a housing having a light transmissible portion engaging a handle portion comprising a hollow body with an opening at one end for engaging a portion of the housing, the handle further comprising an elastomeric or rubberized grip having a flexible property.

12. The work light of claim 1, further comprising a switch adapted to receive a modular electronic control unit.

13. The work light of claim 1, wherein the tray comprises a switch compartment adapted to receive a modular electronic control unit comprising a printed circuit board comprising a mechanical switch in electrical contact with a power source and a light source.

14. The work light of claim 1, wherein the tray comprises a switch compartment adapted to receive a modular electronic control unit comprising a printed circuit board comprising a mechanical switch in electrical contact with a battery power source and a light source.

15. The work light of claim 1, wherein the tray comprises an electronic control compartment adapted to receive a modular electronic control unit comprising a printed circuit board comprising a mechanical switch in electrical contact with a rechargeable battery power source and a light source, the modular electronic control unit further comprising a connector jack for connection to an external power source for recharging the rechargeable battery power source.

16. A work light comprising a compartmentalized tray for holding modularized components including a light source, power source and electrical control unit, wherein the modularized components are assembled on the tray in an operable manner, the tray including barriers between assembled components that limit the movement of the components relative to each other, the tray comprising an electronic control compartment comprising the electronic control unit, a battery compartment comprising the battery and a light source compartment comprising the light source; wherein the tray is surrounded by a casing containing a light transmissible portion enclosed by a cap having a hollow shell body with an opening at one end and a rotatable hook extending from the cap, the housing frictionally engaged to a handle portion.

17. The work light of claim 16 wherein the modularized components are assembled on tray in the Y-Y direction.

18. The work light of claim 16 wherein the power source comprises a rechargeable battery and the electronic control unit further comprises a connector jack for connection to an external power source for recharging the rechargeable battery power source.

19. The work light of claim 16 wherein the handle portion further comprises an elastomeric or rubberized grip.

20. A method for servicing a work light comprising:
removing a cap from the work light housing,
removing a tray containing components of the work light from the work light housing,
replacing a component on the tray of the work light,
inserting the tray into the housing of the work light,
replacing the cap of the work light.
